(19) United States
(12) Patent Application Publication
(10) Pub. No.: US 2012/0164941 A1
(43) Pub. Date: Jun. 28, 2012

(54) BEAM BANDWIDTH ALLOCATION APPARATUS AND METHOD FOR USE IN MULTI-SPOT BEAM SATELLITE SYSTEM

(75) Inventor: Un-Hee PARK, Gwangju-si (KR)

(73) Assignee: ELECTRONICS AND TELECOMMUNICATIONS RESEARCH INSTITUTE, Daejeon-si (KR)

(21) Appl. No.: 13/328,253

(22) Filed: Dec. 16, 2011

(30) Foreign Application Priority Data
Dec. 23, 2010 (KR) 10-2010-0133801

(51) Int. Cl. H04B 7/185

(52) U.S. Cl. 455/13.4; 455/12.1

(57) ABSTRACT

A beam bandwidth allocation method, which is performed by a satellite earth station in a multi-spot beam satellite system, is provided. The beam bandwidth allocation method includes collecting information on a plurality of spot beams and allocating the same power to each of the spot beams and determining bandwidth to be allocated to each of the spot beams based on the collected information.

### CROSS-REFERENCE TO RELATED APPLICATION(S)

This application claims the benefit under 35 U.S.C. §119(a) of Korean Patent Application No. 10-2010-0133801, filed on Dec. 23, 2010, in the Korean Intellectual Property Office, the entire disclosure of which is incorporated herein by reference for all purposes.

### BACKGROUND

1. Field

The following description relates to a multi-spot beam satellite system, and more particularly, to a beam bandwidth allocation apparatus and method for increasing the total amount of transmission capacity.

2. Description of the Related Art

Multi-spot beam antennas, which are one of the most prominent products in the field of satellite communications, realize narrow beam patterns with high directivity, and may thus allow flexible satellite systems to be established through efficient use of limited communication resources and improve communication capacity through provision of communication resources appropriate for the distributed traffic properties of multi-spot beams.

There is a related-art beam bandwidth allocation method in which different levels of power are applied to different spot beams while fixing the positions of spot beams. This related-art technique, however, may increase the cost of establishing a satellite system due to the nonlinearity of power amplifiers that are connected to the spot beams.

### SUMMARY

The following description relates to a beam bandwidth allocation apparatus and method for use in a multi-spot beam satellite system, which are capable of reducing the cost of establishing the multi-spot beam satellite system.

In one general aspect, there is provided a beam bandwidth allocation method, which is performed by a satellite earth station in a multi-spot beam satellite system, the beam bandwidth allocation method including: collecting information on a plurality of spot beams; and allocating the same power to each of the spot beams and determining bandwidth to be allocated to each of the spot beams based on the collected information.

The information on the spot beams may include at least one of an amount of traffic required by each of the spot beams and an amount of attenuation of each of the spot beams.

A combined total amount of bandwidth to be allocated to each of the spot beams may be less than a total amount of bandwidth allocable by a satellite.

The beam bandwidth allocation method may further include transmitting information on the bandwidth to be allocated to each of the spot beams to a satellite.

The beam bandwidth allocation method may further include setting a total number of spot beams allocable by a satellite and a target threshold for a total amount of bandwidth available for use.

The determining of the bandwidth to be allocated to each of the spot beams may include determining one or more spot beams whose required traffic amounts are greater than allocable communication capacity as target spot beams.

The determining of the bandwidth to be allocated to each of the spot beams may further include, in response to a number of target spot beams being less than the total number of spot beams allocable by the satellite, determining bandwidth to be allocated for each of the target spot beams.

The determining of the bandwidth to be allocated to each of the spot beams may include determining a Lagrange multiplier and calculating the bandwidth to be allocated to each of the spot beams based on the Lagrange multiplier.

The determining of the Lagrange multiplier may include calculating a total combined amount of traffic required by each of the spot beams, calculating an initial Lagrange multiplier based on the total combined required traffic amount and calculating the Lagrange multiplier and a maximum and a minimum of the Lagrange multiplier based on the initial Lagrange multiplier.

The determining of the Lagrange multiplier may further include setting the initial Lagrange multiplier as the Lagrange multiplier, setting half the initial Lagrange multiplier as the Lagrange multiplier minimum, and setting a value twice greater than the initial Lagrange multiplier as the Lagrange multiplier maximum.

The beam bandwidth allocation method may further include calculating the total combined bandwidth amount and, in response to the total combined bandwidth amount exceeding the total amount of bandwidth allocable by the satellite, resetting the Lagrange multiplier.

The beam bandwidth allocation method may further include calculating the total combined bandwidth amount and, in response to a difference between the total combined bandwidth amount and the total amount of bandwidth allocable by the satellite being less than the target threshold, resetting the Lagrange multiplier.

In another general aspect, there is provided a satellite earth station that performs beam bandwidth allocation in a multi-spot beam satellite system, the satellite earth station including: a target spot beam determination unit configured to collect information on a plurality of spot beams and determine one or more of the spot beams as target spot beams; and a bandwidth allocation unit configured to determine bandwidth to be allocated to each of the spot beams based on the collected information.

Other features and aspects may be apparent from the following detailed description, the drawings, and the claims.

### BRIEF DESCRIPTION OF THE DRAWINGS

FIG. 1 is a diagram illustrating an example of a multi-spot beam satellite system.

FIG. 2 is a diagram illustrating an example of beam bandwidth allocation that is performed by a multi-spot beam satellite system.

FIG. 3 is a diagram illustrating an example of allocating beam bandwidth to each multi-spot beam.

FIG. 4 is a diagram illustrating an example of a satellite earth station that performs beam bandwidth allocation.

FIGS. 5A and 5B are flowcharts illustrating an example of a beam bandwidth allocation method.

FIG. 6 is a flowchart illustrating an example of determining the amount of bandwidth to be allocated to each beam.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

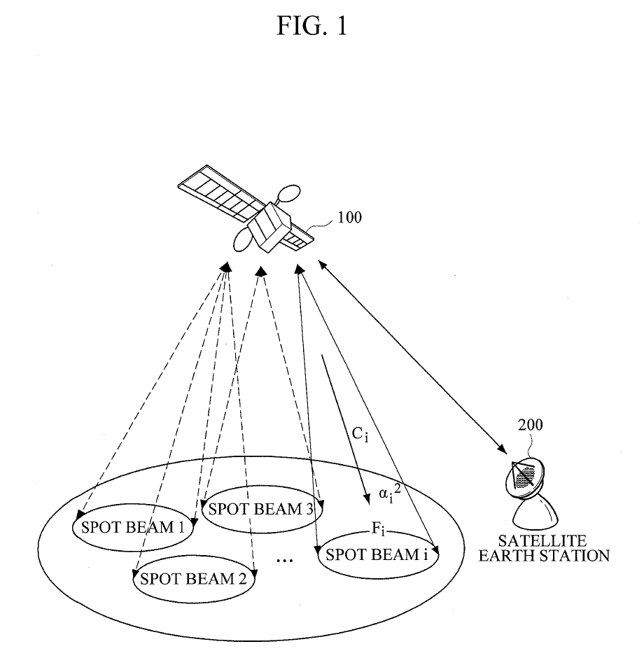

FIG. 1 illustrates an example of a multi-spot beam satellite system. Referring to FIG. 1, a satellite 100 may have broadband properties, and may thus include the coverage of multiple spot beams. The satellite 100 may form a communication link to each spot beam and to a satellite earth station 200. Even though the satellite 100 has a fixed spot beam size, the satellite 100 may form such a narrow beam pattern that the interference between beams may be ignored. The satellite 100 may emit a plurality of spot beams (i.e., first, second, and third spot beams, . . . , and an i-th spot beam) at the same time without any limit to the direction of propagation of the spot beams within the coverage of the satellite 100. A total number N of spot beams that may be emitted by the satellite 100 may satisfy the following equation: M≦N where M denotes the number of spot beams that are actually allocable by the satellite 100.

The satellite earth station 200 may switch the spot beams, may collect communication environment information on each of the spot beams such as, for example, channel information, required traffic amount information, or the like, and may determine communication capacity to be allocated to each of the spot beams based on the collected communication environment information. Referring to FIG. 1, the satellite earth station 200 may determine allocable communication capacity Cᵢ to be allocated to the i-th spot beam based on an amount Fᵢ of traffic that is required by the i-th spot beam and an amount αᵢ² of attenuation of the i-th spot beam, and may transmit the communication capacity Cᵢ to the satellite 100 so that the satellite 100 may allocate the communication capacity Cᵢ to the i-th spot beam.

To maintain the linear properties of one or more amplifiers (not shown) included in the satellite 100, a beam bandwidth allocation apparatus and method, which apply the same power to each of the spot beams, determine an optimum amount of bandwidth to be allocated to each of the spot beams, and allocate the determined optimum amount of bandwidth within the power allocated to each of the spot beams based on the amount of traffic required by each of the spot beams and the attenuation amount of each of the spot beams, may be provided.

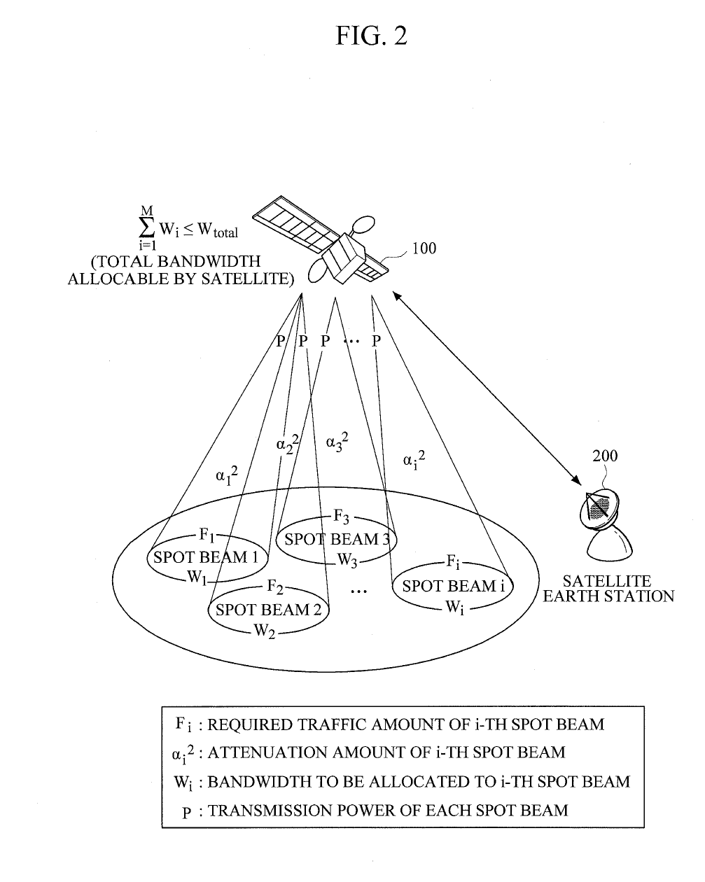

FIG. 2 illustrates an example of beam bandwidth allocation that is performed by a multi-spot beam satellite system.

Referring to FIG. 2, the same power P may be allocated to each of the first, second, and third spot beams, . . . , and the i-th spot beam, and an optimum amount of bandwidth may be allocated to each of the first, second, and third spot beams, . . . , and the i-th spot beam based on required traffic amounts F₁, F₂, F₃, . . . , and Fᵢ and attenuation amounts α₁², α₂², α₃², . . . , and αᵢ² of the first, second, and third spot beams, . . . , and the i-th spot beam so that total communication capacity may be increased. A combined total amount of bandwidth allocated to each of the first, second, and third spot beams, . . . , and the i-th spot beam may not exceed a total amount of bandwidth Wₜₒₜₐₗ that is allocable by the satellite 100.

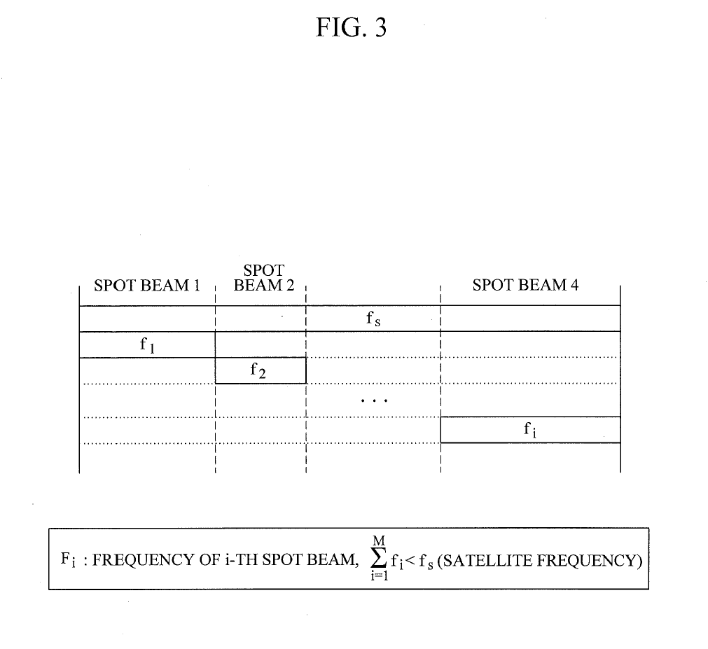

FIG. 3 illustrates an example of allocating bandwidth to each spot beam.

Referring to FIG. 3, the amount of bandwidth to be allocated to each spot beam may not be limited, and an optimum amount of bandwidth may be allocated to each spot beam. That is, a multi-spot beam satellite system may be able to flexibly allocate bandwidth to each spot beam.

The satellite earth station 200 may determine the bandwidth amount Wᵢ, which is the amount of bandwidth to be allocated to the i-th spot beam, and may transmit information on the bandwidth amount Wᵢ to the satellite so that the satellite 100 may transmit data using the bandwidth amount Wᵢ.

One or more factors that the satellite earth station 200 needs to consider to allocate bandwidth to each spot beam are described as follows. In response to the required traffic amount Fᵢ being the same as the communication capacity Cᵢ, total system capacity may reach its maximum. Thus, a multi-spot beam satellite system may be designed such that the difference between the required traffic amount Fᵢ and the communication capacity Cᵢ may be minimized, as indicated by Equation (1):

MinimizeΣ(Fᵢ−Cᵢ)² (1).

Equation (1) is a cost function for optimizing beam bandwidth allocation. To maximize total system capacity, an optimum amount of bandwidth Wₒₚₜ that minimizes the is difference between the required traffic amount Fᵢ and the communication capacity Cᵢ may be determined. Accordingly, it is possible to establish a multi-beam spot satellite system with flexible bandwidth.

Referring to Equation (1), in a case in which the required traffic amount Fᵢ is the same as the communication capacity Cᵢ, the efficiency of resources may be optimized. The less the difference between the required traffic amount Fᵢ and the communication capacity Cᵢ, the higher the total system capacity. In the example illustrated in FIG. 3, beam bandwidth allocation may be performed a spot beam that satisfies Equation (2):

$${C}_{i} = {W}_{i} {log}_{2} ( 1 + \frac{{α}_{i}^{2} P}{{W}_{i} {N}_{0}} ) \leq {F}_{i} . \qquad ( 2 )$$

where N₀ denotes noise power density.

Equation (2) represents a constraint condition for a case in which the required traffic amount Fᵢ is greater than the communication capacity Cᵢ, while Equation (1) represents a constraint function that should be considered during a search for a spot beam that satisfies Equation (1). Referring to Equation (2), a spot beam whose required traffic amount Fᵢ is greater than the communication capacity Cᵢ may be determined as a target spot beam.

ΣWᵢ≦Wₜₒₜₐₗ

Equation (3) represents a constraint function that should be considered during a search for a spot beam that satisfies Equation (1). According to Equation (3), the bandwidth amount Wᵢ is required not to exceed the total allocable bandwidth amount Wₜₒₜₐₗ.

The satellite earth station 200 may perform beam bandwidth allocation in such a manner that Equations (1), (2), and (3) may all be satisfied.

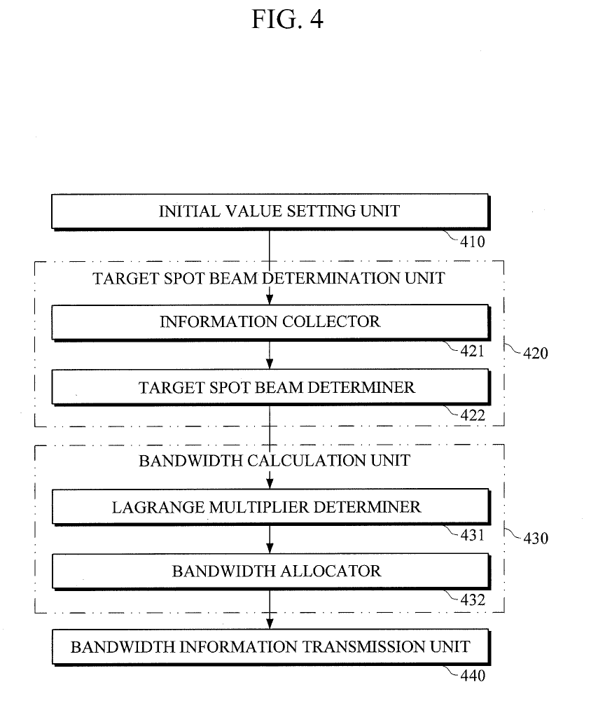

FIG. 4 illustrates an example of a satellite earth station that performs beam bandwidth allocation.

Referring to FIG. 4, satellite earth station 200 includes an initial value setting unit 410, a target spot beam determination unit 420, a bandwidth calculation unit 430, and a bandwidth allocation information transmission unit 440.

The initial value setting unit 410 may set initial values for a total number of spot beams that are allocable by the satellite 100 and a target threshold for a total amount of bandwidth available for use.

The target spot beam determination unit 420 may collect information on a plurality of spot beams, and may select one or more target spot beams based on the collected information. The target spot beam determination unit 420 may include an information collector 421 and a target spot beam determiner 422.

The information collector 421 may collect information on the spot beams, including at least one of required traffic amount information and attenuation amount information. The target spot beam determiner 422 may determine one or more spot beams whose required traffic amount exceeds allocable communication capacity as target spots beam based on the collected information.

The bandwidth calculation unit 430 may determine bandwidth to be allocated to each of the target spot beams based on the collected information. The bandwidth calculation unit 430 may include a Lagrange multiplier determiner 431 and a beam bandwidth allocator 432.

The Lagrange multiplier determiner 431 may determine an optimum Lagrange multiplier for optimizing beam bandwidth allocation. The beam bandwidth allocator 432 may determine an optimum amount of bandwidth (i.e., Wₒₚₜ) for each of the target spot beams based on the optimum Lagrange multiplier.

The bandwidth allocation information transmission unit 440 may transmit information on the optimum bandwidth amount to a satellite (not shown) as a control signal.

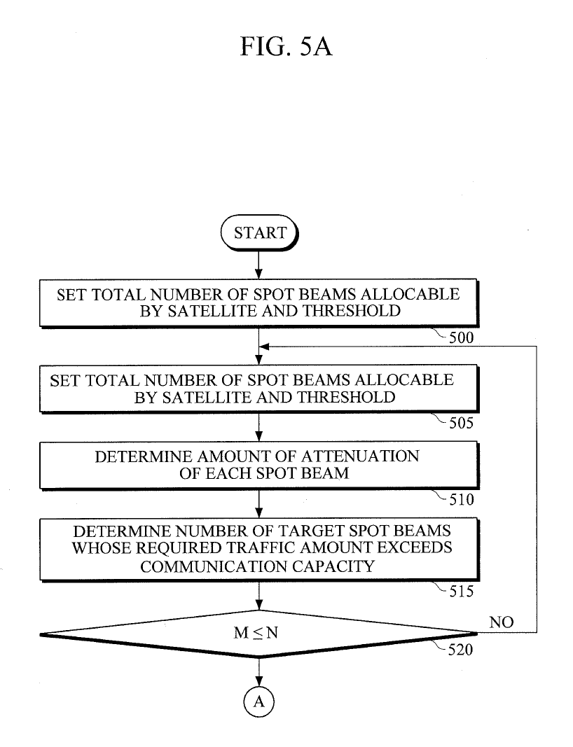

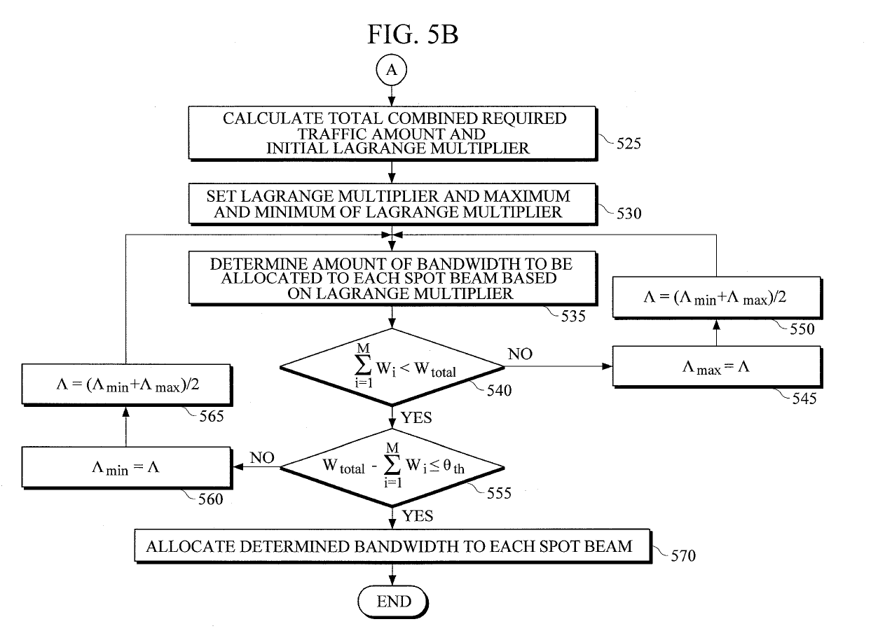

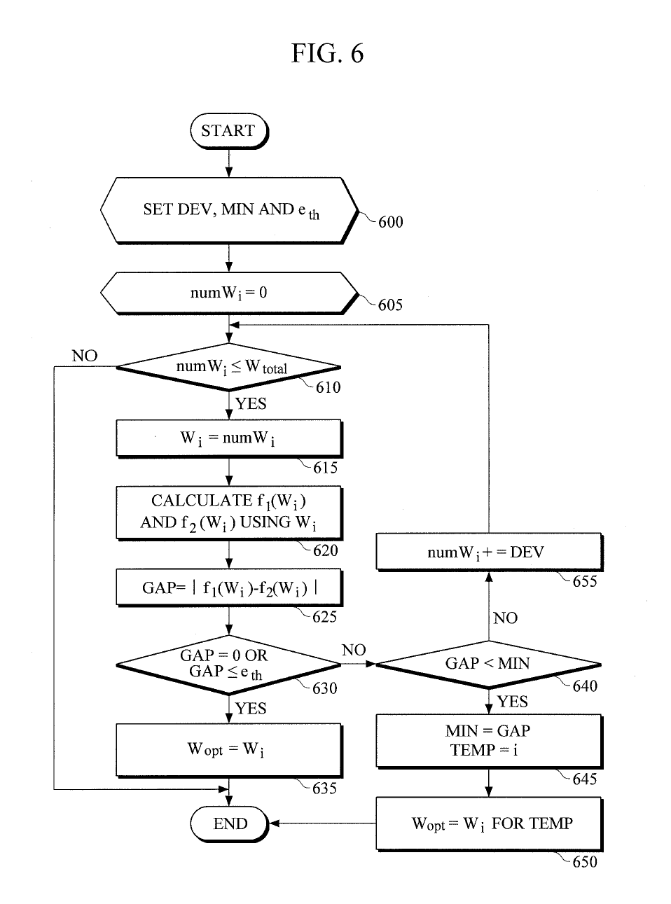

An example of beam bandwidth allocation that is performed by the satellite earth station 200 is further described with reference to FIGS. 5A, 5B, and 6.

FIGS. 5A and 5B illustrate an example of a beam bandwidth allocation method.

Referring to FIG. 5A, in 500, a satellite earth station may set a total number N of spot beams that are allocable by a satellite and a target threshold θₜₕ for a total amount Wₜₒₜₐₗ of total bandwidth allocable.

In 505, the satellite earth station may determine a required traffic amount Fᵢ of an i-th spot beam. In 510, the satellite earth station may determine an attenuation amount αᵢ² of the i-th spot beam.

In 515, the satellite earth station may determine a number M of target spot beams, which are spot beams that satisfy Equation (2). For example, in response to the required traffic amount Fᵢ exceeding communication capacity Cᵢ, the i-th spot beam may be determined as a target spot beam.

In 520, the satellite earth station may determine whether the number M is less than the to number N.

In response to the number M not being less than the number N, the beam bandwidth allocation method returns to 505 so that 505, 510, and 515 may be repeatedly performed until the number M reaches the number N.

In response to the number M being less than the number N, the beam bandwidth allocation method may proceed to 525.

Referring to FIG. 5B, in 525, the satellite earth station may calculate a total required traffic amount Fₛᵤₘ, which is the combined total required traffic amount of all spot beams, and may calculate an initial Lagrange multiplier Λ₀.

An example of calculating the initial Lagrange multiplier Λ₀ is described with Equations (4) through (10).

A Lagrangian function may be applied to an amount Wᵢ of bandwidth to be allocated to the i-th beam, as indicated by Equation (4):

$$L ( {W}_{i} , Λ ) = \sum {[ {F}_{i} - {W}_{i} log ( 1 + \frac{{α}_{i}^{2} P}{{W}_{i} {N}_{0}} ) ]}^{2} + Λ ( \sum {W}_{i} - {W}_{total} ) \qquad ( 4 )$$

where Λ denotes a Lagrange multiplier. The Lagrange multiplier Λ may be determined using Equation (4). As a first step of the Langrangian function for calculating the initial Lagrange multiplier Λ₀, Equation (6) may be derived from Equation (5), and Equation (7), which defines the initial Lagrange multiplier Λ₀, may be derived from Equation (6). Equations (5), (6), and (7) are as follows:

$$\begin{matrix} \frac{\partial L ( {W}_{i} , Λ )}{\partial {W}_{i}} = 0 ; & ( 5 ) \\ {F}_{i} - {W}_{i} {log}_{2} ( 1 + \frac{{α}_{i}^{2} P}{{W}_{i} {N}_{0}} ) = \frac{\frac{Λ {W}_{i} ln 2}{2} ( 1 + \frac{{α}_{i}^{2} P}{{W}_{i} {N}_{0}} )}{{W}_{i} ln 2 ( 1 + \frac{{α}_{i}^{2} P}{{W}_{i} {N}_{0}} ) {log}_{2} ( 1 + \frac{{α}_{i}^{2} P}{{W}_{i} {N}_{0}} ) - \frac{{α}_{i}^{2} P}{{N}_{0}}} ; \\ and & ( 6 ) \\ Λ = \frac{2}{ln 2} [ {F}_{i} - {W}_{i} log ( 1 + \frac{{α}_{i}^{2} P}{{W}_{i} {N}_{0}} ) ] * \frac{ln 2 ( 1 + \frac{{α}_{i}^{2} P}{{W}_{i} {N}_{0}} ) log ( 1 + \frac{{α}_{i}^{2} P}{{W}_{i} {N}_{0}} ) - \frac{{α}_{i}^{2} P}{{W}_{i} {N}_{0}}}{1 + \frac{{α}_{i}^{2} P}{{W}_{i} {N}_{0}}} . & ( 7 )\end{matrix}$$

A second phase of the Lagrangian function for calculating the initial Lagrange multiplier Λ₀ may be defined by Equation (8):

$$\frac{\partial L ( {W}_{i} , Λ )}{\partial Λ} = 0. \qquad ( 8 )$$

Equation (9), which may be derived from Equation (8), may be as follows:

ΣWᵢ=Wₜₒₜₐₗ (9).

Referring to Equation (9), the initial Lagrange multiplier Λ₀ may be determined by a total allocable bandwidth amount Wₜₒₜₐₗ.

To determine the initial Lagrange multiplier Λ₀ using Equations (7) and (9), Wᵢ in Equation (7) may be replaced with ΣWᵢ. In this example, Equation (7) may no longer have a closed form, and thus, an optimum Lagrange multiplier may need to be intuitively determined. To intuitively determine the optimum Lagrange multiplier, the initial Lagrange multiplier Λ₀ may be determined based on the assumption that the total allocable bandwidth amount Wₜₒₜₐₗ is allocated to a spot beam with the total required traffic amount Fₛᵤₘ, as indicated by Equation (10):

$${Λ}_{0} = \frac{2}{ln 2} [ {F}_{sum} - {W}_{total} {log}_{2} ( 1 + \frac{{α}_{i}^{2} P}{{W}_{total} {N}_{0}} ) ] \times \frac{ln 2 ( 1 + \frac{{α}_{i}^{2} P}{{W}_{total} {N}_{0}} ) {log}_{2} ( 1 + \frac{{α}_{i}^{2} P}{{W}_{total} {N}_{0}} ) - \frac{{α}_{i}^{2} P}{{W}_{total} {N}_{0}}}{1 + \frac{{α}_{i}^{2} P}{{W}_{total} {N}_{0}}} . \qquad ( 10 )$$

In 530, the satellite earth station may set a Lagrange multiplier Λ, a minimum Λₘᵢₙ of the Lagrange multiplier Λ, and a maximum Λₘₐₓ of the Lagrange multiplier Λ based on the initial Lagrange multiplier Λ₀. For example, the initial Lagrange multiplier Λ₀ may be set as the initial value of the Lagrange multiplier Λ, the minimum Lagrange multiplier Λₘᵢₙ may be set to Λ₀/2, and the maximum Lagrange multiplier Λₘₐₓ may be set to 2Λ₀. In this example, an optimum Lagrange multiplier may be searched for from the range between the minimum Lagrange multiplier Λₘᵢₙ and the maximum Lagrange multiplier Λₘₐₓ by using a binary search algorithm.

In 535, the satellite earth station may calculate the bandwidth amount Wᵢ based on the Lagrange multiplier Λ set in 530, and this is further described with reference to FIG. 6.

FIG. 6 illustrates an example of determining the bandwidth amount Wᵢ based on the Lagrange multiplier Λ.

Referring to FIG. 6, in 600, the satellite earth station may set an increase DEV in the bandwidth amount Wᵢ, a minimum MIN of a gap GAP between f₁(Wᵢ) and f₂(Wᵢ), and an error threshold eₜₕ.

In 605, the satellite earth station may set a current bandwidth amount numWᵢ as an initial bandwidth amount, that is, the 0-th bandwidth amount. Since the 0-th bandwidth amount is 0, the current bandwidth amount numWᵢ is set to 0.

In 610, the satellite earth station may determine whether the current bandwidth amount numWᵢ is less than the total allocable bandwidth amount Wₜₒₜₐₗ.

In 615, in response to the current bandwidth amount numWᵢ being less than the total allocable bandwidth amount Wₜₒₜₐₗ, the satellite earth station may set the current bandwidth amount num Wᵢ as the bandwidth amount Wᵢ.

In 620, the satellite earth station may calculate f₁(Wᵢ) and f₂(Wᵢ) based on the bandwidth amount Wᵢ, as indicated by Equations (11) and (12):

$$\begin{matrix}{f}_{1} ( {W}_{i} ) = {F}_{i} - {W}_{i} {log}_{2} ( 1 + \frac{{α}_{i}^{2} P}{{W}_{i} {N}_{0}} ) ; \\ and & ( 11 ) \\ {f}_{2} ( {W}_{i} ) = \frac{Λ {W}_{i} ln 2 ( 1 + \frac{{α}_{i}^{2} P}{{W}_{i} {N}_{0}} )}{{W}_{i} ln 2 ( 1 + \frac{{α}_{i}^{2} P}{{W}_{i} {N}_{0}} ) {log}_{2} ( 1 + \frac{{α}_{i}^{2} P}{{W}_{i} {N}_{0}} ) - \frac{{α}_{i}^{2} P}{{N}_{0}}} . & ( 12 )\end{matrix}$$

Equation (6) has no closed form for the bandwidth amount Wᵢ. Thus, in 625, the satellite earth station may calculate the gap GAP, which is the absolute difference between f₁(Wᵢ) and f₂(Wᵢ) by substituting values from 0 to Wₜₒₜₐₗ into Wᵢ of Equation (11) or (12). That is, GAP=|f₁(W₁)−f₂(W₁)|.

In 630, the satellite earth station may determine whether the gap GAP is 0 or less than the error threshold eₜₕ.

In 635, in response to the gap GAP being 0 or less than the error threshold eₜₕ, the satellite earth station may determine the bandwidth amount Wᵢ as the optimum bandwidth amount Wₒₚₜ.

In 640, in response to the gap GAP neither being 0 nor less than the error threshold eₜₕ, the satellite earth station may determine whether the gap GAP is less than the gap minimum MIN.

In 645, in response to the gap GAP being less than the gap minimum MIN, the satellite earth station may set the gap GAP as a new gap minimum MIN, and may set the value of i as TEMP.

In 650, the satellite earth station may determine an amount of bandwidth to be allocated for TEMP as the optimum bandwidth amount Wₒₚₜ.

In 655, in response to the gap GAP not being less than the gap minimum MIN, the satellite earth station may add DEV to the initial bandwidth amount numWᵢ, and the beam bandwidth allocation method returns to 610 so that 610, 615, 620, and 625 may be repeatedly performed until GAP=0 or GAP≦eₜₕ.

Referring back to FIG. 5B, in 540, the satellite earth station may calculate a total amount

$${\sum }_{i = 1}^{M} {W}_{i}$$

of bandwidth to be allocated, and may determine whether the total bandwidth amount

$${\sum }_{i = 1}^{M} {W}_{i}$$

is less than the total allocable bandwidth amount Wₜₒₜₐₗ.

In 545 and 550, in response to the total bandwidth amount

$${\sum }_{i = 1}^{M} {W}_{i}$$

not being less than the total allocable bandwidth amount Wₜₒₜₐₗ, the satellite earth station may reset the Lagrange multiplier Λ and the maximum Lagrange multiplier Λₘₐₓ, and the beam bandwidth allocation method returns to 535. For example, the satellite earth station may reset the current Lagrange multiplier Λ as a new maximum Lagrange multiplier Λₘₐₓ, and may set (Λₘᵢₙ+Λₘₐₓ)/2 as a new Lagrange multiplier Λ.

In 555, in response to the total bandwidth amount

$${\sum }_{i = 1}^{M} {W}_{i}$$

being less than the total allocable bandwidth amount Wₜₒₜₐₗ, the satellite earth station may determine whether a value obtained by subtracting the total bandwidth amount

$${\sum }_{i = 1}^{M} {W}_{i}$$

from the total allocable bandwidth amount Wₜₒₜₐₗ is i less than the target threshold θₜₕ.

In 570, in response to the value obtained by subtracting the total bandwidth amount

$${\sum }_{i = 1}^{M} {W}_{i}$$

from the total allocable bandwidth amount Wₜₒₜₐₗ being less than the target threshold θₜₕ, the satellite earth station may transmit a control signal for allocating the bandwidth amount Wᵢ to each beam to the satellite.

In 560 and 565, in response to the value obtained by subtracting the total bandwidth

$${\sum }_{i = 1}^{M} {W}_{i}$$

amount from the total allocable bandwidth amount Wₜₒₜₐₗ not being less than the target threshold θₜₕ, the satellite earth station may reset the Lagrange multiplier Λ and the minimum Lagrange multiplier θₘᵢₙ, and the beam bandwidth allocation method returns to 535. For example, the satellite earth station may reset the current Lagrange multiplier Λ as a new maximum Lagrange multiplier Λₘᵢₙ, and may set (Λₘᵢₙ+Λₘₐₓ)/2 as a new Lagrange multiplier Λ.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner.

As described above, it is possible to flexibly allocate an optimum amount of bandwidth within each spot beam coverage by reflecting the channel state and the required traffic amount of each beam while uniformly maintaining transmission power. Therefore, it is possible to reduce the cost of establishing a satellite system that may undesirably increase due to nonlinearity caused by power amplifiers.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A beam bandwidth allocation method, which is performed by a satellite earth station in a multi-spot beam satellite system, the beam bandwidth allocation method comprising:
collecting information on a plurality of spot beams; and
allocating the same power to each of the spot beams and determining bandwidth to be allocated to each of the spot beams based on the collected information.

2. The beam bandwidth allocation method of claim 1, wherein the information on the to spot beams comprises at least one of an amount of traffic required by each of the spot beams and an amount of attenuation of each of the spot beams.

3. The beam bandwidth allocation method of claim 1, wherein a combined total amount of bandwidth to be allocated to each of the spot beams is less than a total amount of bandwidth allocable by a satellite.

4. The beam bandwidth allocation method of claim 1, further comprising:
transmitting information on the bandwidth to be allocated to each of the spot beams to a satellite.

5. The beam bandwidth allocation method of claim 1, further comprising:
setting a total number of spot beams allocable by a satellite and a target threshold for a total amount of bandwidth available for use.

6. The beam bandwidth allocation method of claim 5, wherein the determining the bandwidth to be allocated to each of the spot beams, comprises determining one or more spot beams whose required traffic amounts are greater than allocable communication capacity as target spot beams.

7. The beam bandwidth allocation method of claim 6, wherein the determining the bandwidth to be allocated to each of the spot beams, further comprises, in response to a number of target spot beams being less than the total number of spot beams allocable by the satellite, determining bandwidth to be allocated for each of the target spot beams.

8. The beam bandwidth allocation method of claim 1, wherein the determining the bandwidth to be allocated to each of the spot beams, comprises:
determining a Lagrange multiplier; and
calculating the bandwidth to be allocated to each of the spot beams based on the Lagrange multiplier.

9. The beam bandwidth allocation method of claim 8, wherein the determining the Lagrange multiplier comprises:
calculating a total combined amount of traffic required by each of the spot beams;
calculating an initial Lagrange multiplier based on the total combined required traffic amount; and
calculating the Lagrange multiplier and a maximum and a minimum of the Lagrange multiplier based on the initial Lagrange multiplier.

10. The beam bandwidth allocation method of claim 9, wherein the determining the Lagrange multiplier further comprises:
setting the initial Lagrange multiplier as the Lagrange multiplier, setting half the initial Lagrange multiplier as the Lagrange multiplier minimum, and setting a value twice greater than the initial Lagrange multiplier as the Lagrange multiplier maximum.

11. The beam bandwidth allocation method of claim 8, further comprising:
calculating the total combined bandwidth amount and, in response to the total combined bandwidth amount exceeding the total amount of bandwidth allocable by the satellite, resetting the Lagrange multiplier.

12. The beam bandwidth allocation method of claim 9, further comprising:
calculating the total combined bandwidth amount and, in response to a difference between the total combined bandwidth amount and the total amount of bandwidth allocable by the satellite being less than the target threshold, resetting the Lagrange multiplier.

13. A satellite earth station that performs beam bandwidth allocation in a multi-spot beam satellite system, the satellite earth station comprising:
a target spot beam determination unit configured to collect information on a plurality of spot beams and determine one or more of the spot beams as target spot beams; and
a bandwidth allocation unit configured to determine bandwidth to be allocated to each of the spot beams based on the collected information.

14. The satellite earth station of claim 13, wherein the target spot beam determination unit comprises:
an information collector configured to collect at least one of an amount of traffic required by each of the spot beams and an amount of attenuation of each of the spot beams; and
a target spot beam determiner configured to determine a number of target spot beams based on information collected by the information collector

15. The satellite earth station of claim 14, wherein the target spot beam determiner is further configured to determine one or more spot beams whose required traffic amount is greater than allocable communication capacity as target spot beams.

16. The satellite earth station of claim 13, wherein the bandwidth calculation unit comprises:
a Lagrange multiplier determiner configured to determine a Lagrange multiplier for optimizing beam bandwidth allocation; and
a bandwidth allocator configured to determine an optimum amount of bandwidth to be allocated to each of the targets pot beams based on the Lagrange multiplier.

17. The satellite earth station of claim 13, further comprising:
an initial value setter configured to set a number of spot beams allocable by a satellite and a target threshold for a total amount of bandwidth available for use.

18. The satellite earth station of claim 13, further comprising:
a bandwidth allocation information transmission unit configured to transmit information on the bandwidth to be allocated to each of the spot beams to a satellite as a control signal.
